(19) United States
(12) Patent Application Publication
(10) Pub. No.: US 2025/0031120 A1
(43) Pub. Date: Jan. 23, 2025

(54) METHOD PERFORMED BY USER EQUIPMENT, AND USER EQUIPMENT

(71) Applicant: SHARP KABUSHIKI KAISHA, Sakai City, Osaka (JP)

(72) Inventors: FANGYING XIAO, Shanghai (CN); RENMAO LIU, Shanghai (CN)

(21) Appl. No.: 18/716,937

(22) PCT Filed: Dec. 8, 2022
(86) PCT No.: PCT/CN2022/137494

§ 371 Date: Jun. 6, 2024

(30) Foreign Application Priority Data
Dec. 10, 2021 (CN) 202111513523.2

(51) Int. Cl. H04W 36/18; H04W 24/02; H04W 88/06

(52) U.S. Cl. CPC H04W 36/18; H04W 24/02; H04W 88/06

(57) ABSTRACT

Provided by the present invention are a method performed by user equipment, and user equipment. The method includes: if the UE is configured to provide MUSIM assistance information, and the UE requires a MUSIM gap or the MUSIM gap required by the UE is different from a MUSIM gap indicated in the last transmission of a UE assistance information message: initiating transmission of the UE assistance information message to provide one or more preferred MUSIM gaps, and if the UE has a preference for the one or more MUSIM gaps, including a MUSIM gap request list in the UE assistance information message; and receiving a configured RRC reconfiguration message including the MUSIM gap, and if the MUSIM gap is a periodic MUSIM gap, configuring an identity for the MUSIM gap, and if the MUSIM gap is an aperiodic MUSIM gap, skipping configuring an identity for the MUSIM gap.

### TECHNICAL FIELD

The present invention relates to the technical field of wireless communications, and in particular to a method performed by user equipment, and corresponding user equipment.

### BACKGROUND

In recent years, multi-USIM card devices have become increasingly popular. For example, a user may install two USIM cards on a mobile phone supporting a plurality of USIM cards. One of the USIM cards is used for subscribing to private services, and the other USIM card is used for subscribing to office services. Existing devices that support a plurality of USIM cards are implemented on the basis of manufacturers, and have not been standardized by the 3GPP. Therefore, different manufacturers use different implementation means, and behaviors of user equipment (UE) units are likewise different from each other. In existing implementations, if these USIM cards are respectively registered to networks (the USIM cards may be registered to the same network or respectively registered to two or more networks), UE needs to receive paging from these networks. On the basis of transceiving capabilities of the UE, a possible scenario exists in which, when the UE receives paging of a current network, another network also initiates paging for the UE, or when the UE is communicating with a network, another network initiates paging for the UE. If the UE switches between different networks, a possible result is that the UE can no longer receive data from the current network when the UE switches to another network. This would compromise network performance. For example, the network transmits paging to the UE, but the UE does not receive this paging because the UE has switched to another network, or the UE switches to another network and therefore cannot receive scheduling of the current network. Some manufacturers proposed 3GPP standardization study on network accessing behaviors of UE having a plurality of USIM cards and related networks, the benefit of which is that network performance can be improved on the basis of predictable UE behaviors.

On the basis of the above-described reason, in December 2019, a work item for multi-SIM card devices in Release 17 was proposed by vivo at the 3rd Generation Partnership Project (3GPP) RAN #86 plenary meeting (see Non-Patent Document: RP-193263: New WID: Support of Multi-SIM devices in Rel-17), and was approved. One of the objectives of the work item is to define a mechanism for notifying network A when UE leaves network A. Network A is NR, and network B is LTE or NR. The UE is single-Rx/single-Tx, or the UE is dual-Rx/single-Tx.

The present disclosure discusses relevant problems involved in achieving the above work objectives.

### SUMMARY

In order to address at least part of the aforementioned issues, the present invention provides a method performed by user equipment, and user equipment.

A method performed by user equipment according to a first aspect of the present invention comprises: determining whether one or more configured multi-universal subscriber identity module (MUSIM) gaps are required; and if it is determined that the one or more configured MUSIM gaps are not required: including a MUSIM gap release request list musim-GapReleaseRequestList in a UE assistance information message, including the index of the configured MUSIM gap not required or configuration information of the MUSIM gap in musim-GapReleaseRequestList, and discarding the MUSIM gap indicated in musim-GapReleaseRequestList; otherwise, skipping including musim-GapReleaseRequestList in the UE assistance information message.

A method performed by user equipment according to a second aspect of the present invention comprises: determining whether one or more preferred multi-universal subscriber identity module (MUSIM) gaps are present; and if it is determined that the one or more preferred MUSIM gaps are present: including a MUSIM gap request list musim-GapRequestList in a UE assistance information message, and discarding a configured MUSIM gap not comprised in musim-GapRequestList; otherwise, skipping including musim-GapRequestList in the UE assistance information message, and discarding all of the configured MUSIM gaps.

In the method according to the first aspect or the second aspect of the present invention, the MUSIM gap is discarded only after an RRC layer receives, from a radio link control (RLC) entity, acknowledgment feedback for the UE assistance information message or hybrid automatic repeat request (HARQ) acknowledgment feedback.

A method performed by user equipment according to a third aspect of the present invention comprises: determining whether one or more configured multi-universal subscriber identity module (MUSIM) gaps are required; and if it is determined that the one or more configured MUSIM gaps are not required: including musim-GapReleaseRequestList in a UE assistance information message, including the index of the configured MUSIM gap not required or configuration information of the MUSIM gap in musim-GapReleaseRequestList, and instructing a MAC entity to stop using the MUSIM gap indicated in musim-GapReleaseRequestList; otherwise, skipping including musim-GapReleaseRequestList in the UE assistance information message.

In the method according to the third aspect of the present invention, if it is determined that the one or more configured MUSIM gaps are not required, the MAC entity is first instructed to stop using the MUSIM gap indicated in musim-GapReleaseRequestList, then musim-GapReleaseRequestList is included in the UE assistance information message, and the index of the configured MUSIM gap not required or configuration information of the MUSIM gap is included in musim-GapReleaseRequestList.

A method performed by user equipment according to a fourth aspect of the present invention comprises: determining whether one or more preferred multi-universal subscriber identity module (MUSIM) gaps are present; and if it is determined that the one or more preferred MUSIM gaps are present: including musim-GapRequestList in a UE assistance information message, and instructing a MAC entity to stop using a configured MUSIM gap not comprised in musim-GapRequestList; otherwise, skipping including musim-GapRequestList in the UE assistance information message, and instructing the MAC entity to stop using all of the configured MUSIM gaps.

In the method according to the fourth aspect of the present invention, if it is determined that the one or more preferred MUSIM gaps are present, the MAC entity is first instructed to stop using the configured MUSIM gap not comprised in musim-GapRequestList, and then musim-GapRequestList is included in the UE assistance information message.

In the method according to the third aspect or the fourth aspect of the present invention, the MAC entity is instructed to stop using the MUSIM gap only after an RRC layer receives, from a radio link control (RLC) entity, acknowledgment feedback for the UE assistance information message or hybrid automatic repeat request (HARQ) acknowledgment feedback.

User equipment according to a fifth aspect of the present invention comprises: a processor; and a memory storing instructions, wherein the instructions, when run by the processor, perform the method according to any one of the first aspect to the fourth aspect.

### Beneficial Effects of Present Invention

According to the solution of the present patent, in an application scenario in which UE having a MUSIM card accesses a network, i.e., in the case that UE is handed over between different networks, when the UE requests a current network to release a scheduling gap related to another network, the UE can receive, after transmitting the request, data from the current network within a time period corresponding to the scheduling gap requested to be released, thereby improving network performance.

### BRIEF DESCRIPTION OF THE DRAWINGS

The above and other features of the present invention will be more apparent from the following detailed description in combination with the accompanying drawings, in which:

FIG. 1 is a schematic diagram showing a basic procedure of Scenario 1 (an explicit manner) of a method performed by user equipment according to Embodiment 1 of the present invention.

FIG. 2 is a schematic diagram showing a basic procedure of Scenario 2 (an implicit manner) of the method performed by user equipment according to Embodiment 1 of the present invention.

FIG. 3 is a schematic diagram showing a basic procedure of Scenario 1 (an explicit manner) of a method performed by user equipment according to Embodiment 2 of the present invention.

FIG. 4 is a schematic diagram showing a basic procedure of Scenario 2 (an implicit manner) of the method performed by user equipment according to Embodiment 2 of the present invention.

FIG. 5 is a block diagram showing user equipment according to an embodiment of the present invention.

### DETAILED DESCRIPTION

The following describes the present disclosure in detail with reference to the accompanying drawings and specific embodiments. It should be noted that the present disclosure should not be limited to the specific embodiments described below. In addition, for simplicity, detailed description of the prior art not directly related to the present disclosure is omitted to prevent confusion in understanding the present disclosure.

The following describes some terms involved in the present disclosure. For the specific meanings of the terms, refer to the latest relevant 3GPP documents, for example, TS38.300, TS38.331, TS36.300, TS36.331, etc.
NAS: Non-Access Stratum.
AS: Access Stratum.
RRC: Radio Resource Control.
RRC CONNECTED: RRC connected state.
RRC_INACTIVE: RRC inactive state.
RRC_IDLE: RRC idle state.
RAN: Radio Access Network.
USIM: Universal Subscriber Identity Module.
MUSIM: Multi-Universal Subscriber Identity Module.
Tx: transmitter.
Rx: receiver.
NR: New RAT, New Radio Access Technology.

In the present disclosure, a network, a base station, and a RAN may be used interchangeably. The network may be a Long Term Evolution (LTE) network, an NR network, an enhanced Long Term Evolution (eLTE) network, or another network defined in a subsequent evolved version of the 3GPP.

In the present disclosure, user equipment (UE) may refer to a device that physically supports a plurality of USIM cards (two or more USIM cards). The device is equipped with two or more USIM cards, and each USIM card is associated with one network. The plurality of USIM cards may be from the same operator or different operators. From the perspective of the networks, different USIM cards correspond to different UEs, and each USIM card corresponds to one UE. Unless otherwise specified, the present disclosure does not distinguish therebetween. Those skilled in the art can easily determine, according to the context, whether UE refers to UE supporting a plurality of USIM cards or UE respectively corresponding to each USIM card in a device supporting a plurality of USIM cards. User equipment configured with a plurality of USIM cards can receive and/or transmit data from and/or to a plurality of networks by using single-Rx/single-Tx or dual-Rx/single-Tx via means such as time division multiplexing, and for UE having two Rxs, the UE can simultaneously receive data from two networks. In addition, the USIM in the present disclosure can be a physical SIM or an eSIM.

In examples of embodiments of the present disclosure, UE is configured with two USIM cards, and those skilled in the art can easily expand the same to cases of a plurality of USIM cards. User equipment (UE) having two USIM cards at least has single-Rx/single-Tx or dual-Rx/single-Tx capabilities. Different UEs corresponding to two USIMs may share one pair of Tx's and Rx's, or may share one Tx but respectively have respective Rx's.

The following describes a procedure of UE requesting, for the purpose of a MUSIM (because the UE needs to communicate with another network), a current network to configure a scheduling gap. In the MUSIM, scheduling gaps (alternatively referred to as MUSIM gaps) are divided into two types: one type is a periodic scheduling gap, and the other type is an aperiodic scheduling gap. The periodic scheduling gap is a scheduling gap that periodically occurs after configuration. The aperiodic scheduling gap is a scheduling gap that is used only once after configuration. In a time period corresponding to a MUSIM gap (i.e., during the MUSIM gap), the UE maintains an RRC connection to a current network, but communicates with another network, for example, receives data from the other network without establishing an RRC connection to the other network.

During the MUSIM gap, on the current network (all serving cells or all frequencies of the current network), a MAC entity may perform at least one of the following:
1. skipping performing transmission of hybrid automatic repeat request (HARQ) feedback, a scheduling request (SR), and channel state information (CSI);
2. skipping reporting a sounding reference signal (SRS);
3. skipping transmission on an uplink shared channel (UL-SCH) (optionally, a random access procedure message 3Msg3 or a message A MSGA payload may be transmitted); and
4. skipping monitoring a physical downlink control channel (PDCCH), and skipping receiving a downlink shared channel (DL-SCH) (optionally, the PDCCH is monitored only when a random access response window ra-ResponseWindow or a random access contention resolution timer ra-ContentionResolutionTimer or a message B response window msgB-ResponseWindow is running).

The present disclosure mainly discusses issues related to the periodic scheduling gap.

In a MUSIM scenario, the UE is in an RRC connected state in network A (i.e., a base station), but the UE needs/wishes to communicate with network B, e.g., receive a paging message from network B or perform measurement in network B. In this case, the UE transmits, to network A, indication information of requesting a MUSIM gap. Specifically, when UE having and providing MUSIM assistance information requires a MUSIM gap, if the UE is configured to provide the MUSIM assistance information, and if the UE determines that the MUSIM gap is required or determines to change MUSIM gap information without leaving an RRC CONNECTED state, the UE initiates a UE assistance information transmission procedure. Details are described below.

If the UE is configured to provide the MUSIM assistance information, and furthermore, if the UE requires the MUSIM gap or current MUSIM assistance information is different from MUSIM assistance information indicated in the last transmission of a UEAssistanceInformation message (i.e., the MUSIM gap required by the UE changes, and a current MUSIM gap is different from a MUSIM gap indicated in the last transmission of the UEAssistanceInformation message), initiate transmission of the UEAssistanceInformation message to provide the MUSIM assistance information.

If the UE requires the MUSIM gap or the required MUSIM gap changes, initiation of transmission of the UEAssistanceInformation message to provide the MUSIM assistance information includes the following operation: if the UE has a preference for one or more MUSIM gaps, including a MUSIM gap request list musim-GapRequestList in the UEAssistanceInformation message; otherwise (the UE does not require the MUSIM gap or the required MUSIM gap does not change), musim-GapRequestList is not included in the UEAssistanceInformation message.

When the MUSIM gap required by the UE changes, for example, one or more configured MUSIM gaps need to be released, the UE may explicitly or implicitly request the base station (or the current network) to release the MUSIM gap not required. If explicit indication is used, the UE may indicate, to the base station, the index of the MUSIM gap requested to be released (i.e., no longer required) thereby or indicate, to the base station, configuration information of the MUSIM gap requested to be released thereby. That is, the UEAssistanceInformation message includes the index of the MUSIM gap requested to be released by the UE or the configuration information of the MUSIM gap requested to be released by the UE. If implicit indication is used, the UE may indicate, to the base station, the MUSIM gap required to be configured thereby. That is, the UEAssistanceInformation message includes the MUSIM gap required by the UE. It is indicated that the UE requests the base station to release the configured MUSIM gap not included in the UEAssistanceInformation message.

When the base station receives the UEAssistanceInformation message, if the message includes the MUSIM gap that is requested by the UE to be configured, the base station configures the corresponding MUSIM gap for the UE via an RRC reconfiguration RRCReconfiguration message. Specifically, the base station configures the MUSIM gap for the UE via musim-GapConfig carried in the RRCReconfiguration message. Optionally, the base station specifies an index (referred to as musim-GapIndex) for each MUSIM gap. Since aperiodic gaps are automatically released after use, it may be specified that the base station designates an index for only a periodic scheduling gap, but does not designate an index for an aperiodic scheduling gap, thereby reducing signaling overhead. In other words, an index can be specified for only a MUSIM gap configured with a MUSIM gap repetition period musim-GapRepetitionPeriod.

When the UE starts a UEAssistanceInformation message transmission procedure to request the base station to release one or more MUSIM gaps, when the UE discards (or releases) the MUSIM gap is an urgent problem to be solved.

### Embodiment 1

In an embodiment (Embodiment 1), after transmitting a UEAssistanceInformation message requesting to release a MUSIM gap, UE discards the MUSIM gap requested to be released (or a configuration of the MUSIM gap).

The following describes in detail operations of the UE explicitly and implicitly instructing a base station to release a MUSIM gap not required.

### Scenario 1: The UE Explicitly Instructs the Base Station to Release the MUSIM Gap not Required

If the UE requires a MUSIM gap or the required MUSIM gap changes, initiation of transmission of the UEAssistanceInformation message to provide MUSIM assistance information includes the following operations:

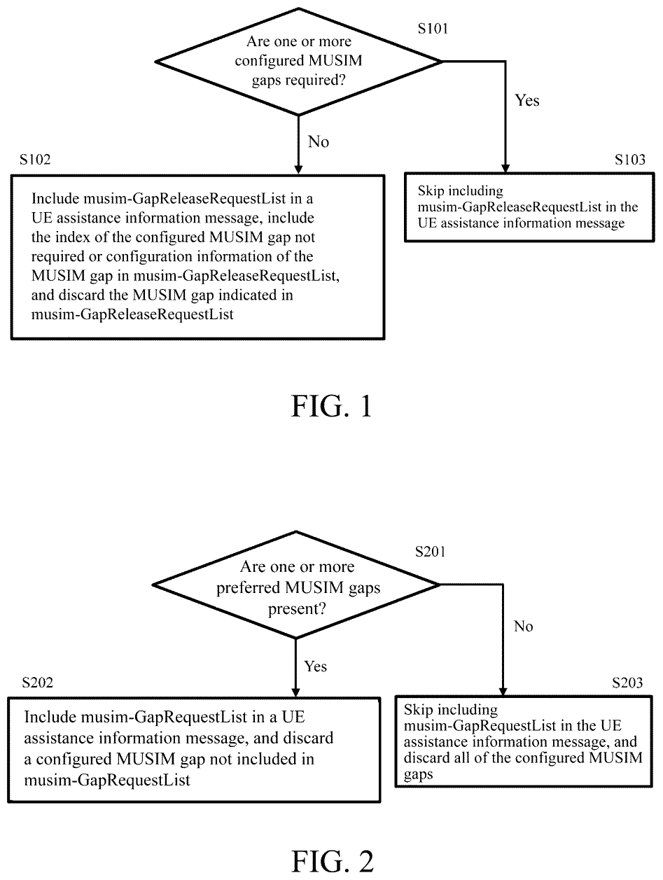

As shown in FIG. 1, in step S101, determining, by UE, whether one or more configured MUSIM gaps are required, and if the UE does not require the one or more configured MUSIM gaps (i.e., the result of the above-described determination is “no”), entering step S102, including a MUSIM gap release request list musim-GapReleaseRequestList in a UEAssistanceInformation message, including the index of the configured MUSIM gap not required or configuration information of the MUSIM gap in musim-GapReleaseRequestList, and discarding the MUSIM gap (or a configuration thereof) indicated in musim-GapReleaseRequestList.

Otherwise (the UE does not have a configured MUSIM gap not required) (i.e., the result of the above-described determination is “yes”), entering step S103, and skipping including musim-GapReleaseRequestList in the UEAssistanceInformation message.

### Scenario 2: The UE Implicitly Instructs the Base Station to Release the MUSIM Gap not Required

If the UE requires the MUSIM gap or the required MUSIM gap changes, initiation of transmission of the UEAssistanceInformation message to provide MUSIM assistance information includes the following operations:

As shown in FIG. 2, in step S201, determining, by UE, whether one or more preferred MUSIM gaps are present, and if the UE has a preference for the one or more MUSIM gaps (i.e., the result of the above-described determination is “yes”), entering step S202, including musim-GapRequestList in a UEAssistanceInformation message, and discarding a configured MUSIM gap (or a configuration thereof) not included in musim-GapRequestList (the discarding operation is performed only if such a MUSIM gap is present).

Otherwise (the UE does not require the MUSIM gap) (i.e., the result of the above-described determination is “no”), entering step S203, skipping including musim-GapRequestList in the UEAssistanceInformation message, and discarding all of the configured MUSIM gaps (or configurations thereof) (the discarding operation is performed only if such MUSIM gaps are present).

Optionally, in the above-described Scenario 1 or Scenario 2, the MUSIM gap (or the configuration thereof) is discarded only after an RRC layer receives, from a radio link control (RLC) entity, acknowledgment feedback for the UEAssistanceInformation message or hybrid automatic repeat request (HARQ) acknowledgment feedback.

### Embodiment 2

In an embodiment (Embodiment 2), a base station configures and releases a MUSIM gap. That is, upon receiving an RRC message (e.g., an RRCReconfiguration message) from the base station, UE releases a corresponding MUSIM gap according to indication of the message.

Specifically, in an implementation, the index of the MUSIM gap to be released is indicated in the RRCReconfiguration message. After receiving the RRC reconfiguration RRCReconfiguration message, the UE discards the MUSIM gap (or a configuration thereof) corresponding to the index. Optionally, in an implementation, configuration information of the MUSIM gap to be released is indicated in the RRCReconfiguration message. After receiving the RRC reconfiguration message, the UE discards the MUSIM gap (or the configuration thereof) corresponding to the configuration. Optionally, in an implementation, configuration information of a MUSIM gap to be configured is indicated in the RRCReconfiguration message. After receiving the RRC reconfiguration message, the UE discards the configured MUSIM gap (or the configuration thereof) not included in the RRCReconfiguration message. This may be implemented by means of setting, to Need R, musim-GapConfig or an attribute (or a Need code) of a field musim-GapUE included in musim-GapConfig for indicating MUSIM gap configurations applied to all frequencies. Need R is used for a field stored by the UE, i.e., non-disposable. Upon receiving a message in which the field is not present, the UE releases a current value. Optionally, in an implementation, the RRCReconfiguration message includes an indication musim-GapReleaseIndication for releasing the MUSIM gap, and musim-GapReleaseIndication can be configured only after a UE assistance information message for requesting to release the MUSIM gap is received from the UE. After receiving the RRCReconfiguration message including musim-GapReleaseIndication, the UE discards the MUSIM gap (or the configuration thereof) having been requested to be released.

For the embodiment (i.e., Embodiment 2) in which the MUSIM gap not required is discarded on the basis of the received RRCReconfiguration message, after the UE transmits the UE assistance information message for requesting to release the MUSIM gap, the base station does not schedule the UE during a scheduling gap corresponding to the MUSIM gap. However, since UE no longer requires the MUSIM gap, if, after the UE requests to release a certain scheduling gap, the UE does not stop using the scheduling gap before receiving a release indication from the base station, resources are wasted, and the throughput of the UE in a current network is reduced. The following provides embodiments to solve the problem.

The following describes embodiments in which the UE explicitly and implicitly instructs the base station to release the MUSIM gap not required.

### Scenario 1: An Embodiment Based on the UE Explicitly Instructing the Base Station to Release the MUSIM Gap not Required

If the UE requires the MUSIM gap or the required MUSIM gap changes, initiation of transmission of the UEAssistanceInformation message to provide MUSIM assistance information includes the following operations:

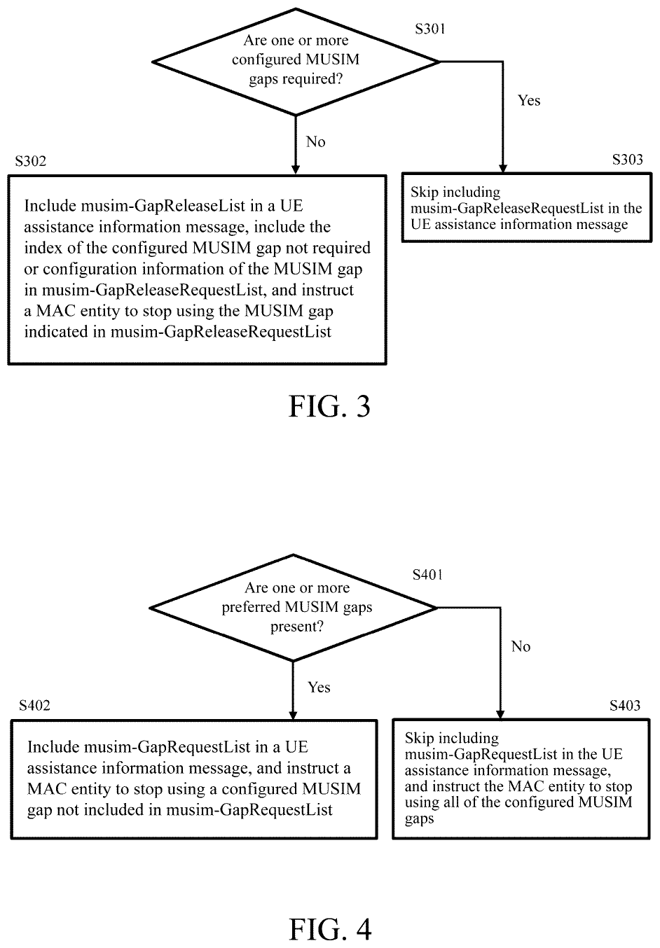

As shown in FIG. 3, in step S301, determining, by UE, whether one or more configured MUSIM gaps are required, and if the UE does not require the one or more configured MUSIM gaps (i.e., the result of the above-described determination is “no”), entering step S302, including musim-GapReleaseRequestList in a UEAssistanceInformation message, including the index of the configured MUSIM gap not required or configuration information of the MUSIM gap in musim-GapReleaseRequestList, and instructing a MAC entity to stop using the MUSIM gap indicated in musim-GapReleaseRequestList.

Otherwise (the UE does not have a configured MUSIM gap not required) (i.e., the result of the above-described determination is “yes”), entering step S303, and skipping including musim-GapReleaseRequestList in the UEAssistanceInformation message.

It should be noted that as an alternative embodiment of the above-described embodiment, the MAC entity may be first instructed to stop using the MUSIM gap not required, then musim-GapReleaseRequestList is included in the UEAssistanceInformation message, and the index of the configured MUSIM gap not required or configuration information of the MUSIM gap is included in musim-GapReleaseRequestList.

### Scenario 2: An Embodiment Based on the UE Implicitly Instructing the Base Station to Release the MUSIM Gap not Required

If the UE requires the MUSIM gap or the required MUSIM gap changes, initiation of transmission of the UEAssistanceInformation message to provide MUSIM assistance information includes the following operations:

As shown in FIG. 4, in step S401, determining, by UE, whether one or more preferred MUSIM gaps are present, and if the UE has a preference for the one or more MUSIM gaps (i.e., the result of the above-described determination is “yes”), entering step S402, including musim-GapRequestList in a UEAssistanceInformation message, and instructing a MAC entity to stop using a configured MUSIM gap not included in musim-GapRequestList (the instruction operation is performed only if such a MUSIM gap is present).

Otherwise (the UE does not require the MUSIM gap) (i.e., the result of the above-described determination is “no”), entering step S403, skipping including musim-GapRequestList in the UEAssistanceInformation message, and instructing the MAC entity to stop using all of the configured MUSIM gaps (the instruction operation is performed only if such MUSIM gaps are present).

Optionally, the MAC entity is instructed to stop using the MUSIM gaps only after an RRC layer receives, from an RLC entity, acknowledgment feedback for the UEAssistanceInformation message or HARQ acknowledgment feedback.

It should be noted that a new embodiment can be obtained by exchanging the operations in the above-described embodiment. That is, the MAC entity is first instructed to stop using the configured MUSIM gap not required, and then musim-GapRequestList is included in the UEAssistanceInformation message to indicate the MUSIM gap required or preferred thereby.

The following describes operations performed by the MAC entity upon receiving from an upper layer for stopping using one or more MUSIM gaps.

If the MAC entity is configured with the MUSIM gap but is not instructed (or instructed by the upper layer) to stop using the MUSIM gap, for the MUSIM gap, during the MUSIM gap, on a current network (all serving cells or all frequencies of the current network), the MAC entity may perform at least one of the following:
1. skipping performing transmission of hybrid automatic repeat request (HARQ) feedback, a scheduling request (SR), and channel state information (CSI);
2. skipping reporting a sounding reference signal (SRS);
3. skipping transmission on an uplink shared channel (UL-SCH) (optionally, a random access procedure message 3Msg3 or a message A MSGA payload may be transmitted); and
4. skipping monitoring a physical downlink control channel (PDCCH), and skipping receiving a downlink shared channel (DL-SCH) (optionally, the PDCCH is monitored only when a random access response window ra-ResponseWindow or a random access contention resolution timer ra-ContentionResolutionTimer or a message B response window msgB-ResponseWindow is running).

The following describes the meaning of some messages or fields involved in the present disclosure.

The UEAssistanceInformation message is used for indicating UE assistance information to the network.

The musim-AssistanceConfig field (which may also be referred to as the musim-AssistanceConfig-Gap field) configures the UE to report the assistance information, that is, configures the UE to report the MUSIM gap preferred thereby and/or a release preference thereof for the purpose of the MUSIM. The base station may instruct, via the musim-AssistanceConfig field carried in the RRC message (e.g., the RRCReconfiguration message), the UE to report the MUSIM gap preferred thereby and/or the release preference thereof for the purpose of the MUSIM.

musim-GapRequestList indicates the MUSIM gap that the UE requests to configure. An element in musim-GapRequestList may be referred to as MUSIM-GapInfo, and is for indicating some or all of information such as musim-GapOffset, musim-GapLength, and musim-GapRepetitionPeriod of each gap. musim-GapOffset indicates a gap offset of the MUSIM gap preferred by the UE. musim-GapLength indicates the length of the MUSIM gap preferred by the UE. musim-GapRepetitionPeriod indicates a gap repetition period of the MUSIM gap preferred by the UE.

musim-GapReleaseRequestList indicates a configuration of the MUSIM gap that the UE requests to release.

musim-GapConfig specifies the configuration of the MUSIM gap, and controls setup and release of the same.

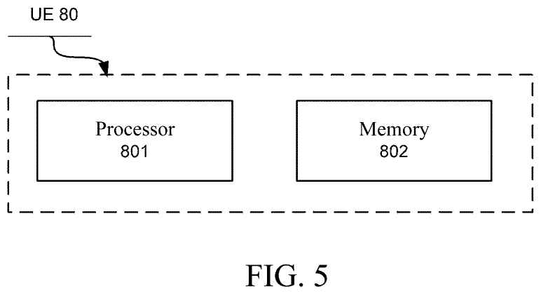

FIG. 5 is a simplified structural block diagram of user equipment (UE) according to the present invention. As shown in FIG. 5, user equipment (UE) 80 includes a processor 801 and a memory 802. The processor 801 may include, for example, a microprocessor, a microcontroller, an embedded processor, and the like. The memory 802 may include, for example, a volatile memory (such as a random access memory (RAM)), a hard disk drive (HDD), a non-volatile memory (such as a flash memory), or other memories, etc. The memory 802 has program instructions stored thereon. The instructions, when run by the processor 801, can implement the above method performed by user equipment as described in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The computer-executable instructions or program for implementing the functions of the embodiments of the present disclosure may be recorded on a computer-readable storage medium. The corresponding functions may be achieved by reading programs recorded on the recording medium and executing the programs by a computer system. The phrase “computer system” herein may be a computer system embedded in the device, which may include operating systems or hardware (e.g., peripherals). The “computer-readable storage medium” may be a semiconductor recording medium, an optical recording medium, a magnetic recording medium, a short-time dynamic memory program recording medium, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1-2. (canceled)

3. A User Equipment (UE), comprising a processor configured to:
determine that (i) the UE is configured to provide multi-universal subscriber identity module (MUSIM) assistance information, and (ii) the UE has a preference for one or more MUSIM gaps or one or more current preferred MUSIM Gaps are different from one or more MUSIM Gaps indicated in last transmission of a UEAssistanceInformation message;
initiate transmission of a UEAssistanceInformation message to provide one or more preferred MUSIM gaps;
if the UE has the preference for the one or more MUSIM gaps,
include the one or more preferred MUSIM gaps in the UEAssistanceInformation message; and
receive an RRCReconfiguratin message which configures a MUSIM gap for the UE, wherein:
in a case that the MUSIM gap is a periodic MUSIM gap, an identity is configured for the MUSIM gap; and
in a case that the MUSIM gap is an aperiodic MUSIM gap, the identity is not configured for the MUSIM gap.

4. A base station, comprising a processor configured to:
determine that (i) a User Equipment (UE) is configured to provide multi-universal subscriber identity module (MUSIM) assistance information, and (ii) the UE has a preference for one or more MUSIM gaps or one or more current preferred MUSIM Gaps are different from one or more MUSIM Gaps indicated in a last UEAssistanceInformation message;
receive a UEAssistanceInformation message to provide one or more preferred MUSIM gaps from the UE, wherein
if the UE has the preference for the one or more MUSIM gaps,
the one or more preferred MUSIM gaps are included in the UEAssistanceInformation message; and
transmit an RRCReconfiguratin message which configures a MUSIM gap for the UE, wherein:
in a case that the MUSIM gap is a periodic MUSIM gap, an identity is configured for the MUSIM gap; and
in a case that the MUSIM gap is an aperiodic MUSIM gap, the identity is not configured for the MUSIM gap.

5. A method performed by a User Equipment (UE), the method comprising:
determine that (i) the UE is configured to provide multi-universal subscriber identity module (MUSIM) assistance information, and (ii) the UE has a preference for one or more MUSIM gaps or one or more current preferred MUSIM Gaps are different from one or more MUSIM Gaps indicated in last transmission of a UEAssistanceInformation message;
initiating transmission of a UEAssistanceInformation message to provide one or more preferred MUSIM gaps; and
if the UE has the preference for the one or more MUSIM gaps,
including the one or more preferred MUSIM gaps in the UEAssistanceInformation message; and
receiving an RRCReconfiguratin message which configures a MUSIM gap for the UE, wherein:
in a case that the MUSIM gap is a periodic MUSIM gap, an identity is configured for the MUSIM gap; and
in a case that the MUSIM gap is an aperiodic MUSIM gap, the identity is not configured for the MUSIM gap.
